(19) United States
(12) Patent Application Publication
(10) Pub. No.: US 2024/0308746 A1
(43) Pub. Date: Sep. 19, 2024

(54) FLEXIBLE ENCLOSURE HAVING A TEAR STRIP

(71) Applicant: Illinois Tool Works Inc., Glenview, IL (US)

(72) Inventors: Jose Manuel Septien Rojas, Naperville, IL (US); David J. Matthews, Gilman, IL (US); Eric Plourde, Frankfort, IL (US); Clifton R. Howell, Elburn, IL (US)

(73) Assignee: Illinois Tool Works Inc., Glenview, IL (US)

(21) Appl. No.: 18/604,215

(22) Filed: Mar. 13, 2024

Related U.S. Application Data
(60) Provisional application No. 63/490,513, filed on Mar. 15, 2023.

(51) Int. Cl. B65D 75/58; B31B 70/81; B65D 33/25

(52) U.S. Cl. CPC B65D 75/5844; B31B 70/8131; B65D 33/2508

(57) ABSTRACT

Flexible enclosure includes a front sidewall and a back sidewall and also includes a resealable assembly having first and second zipper segments that are coupled with the front and back sidewalls, respectively. The first and second zipper segments are mateable with and releasable from each other. The flexible enclosure also includes a tear strip having an elongated strip body that extends along the front sidewall. The tear strip also includes a pull tab that is accessible to a user along the front sidewall. The strip body defines an integrated portion of at least one of the first and second zipper segments. The strip body breaks from the resealable assembly and tears an access opening through the front sidewall when the pull tab is pulled away from the front sidewall by the user.

### CROSS-REFERENCE TO RELATED APPLICATIONS

This application claims priority to U.S. Provisional Application No. 63/490,513 (filed 15 Mar. 2023), the entire disclosure of which is incorporated herein by reference.

### FIELD

The subject matter of the present application relates to flexible enclosures that include tear strips for initially opening and methods of manufacturing the same.

### BACKGROUND

Flexible enclosures (e.g., box lines, plastic packages, and the like) can be used to hold a wide variety of contents. Flexible enclosures have become more popular because such enclosures can cost less than alternatives and can be readily opened but also sealed to provide sufficient protection of the contents therein. A flexible enclosure enables a user to repeatedly open the enclosure, remove a portion of the contents from the enclosure, and then close the enclosure in a manner that seals the contents therein. In many cases, these flexible enclosures are torn or ripped when initially opened. Despite being irreparably altered, the flexible enclosures are configured to reseal the opening to protect the contents from the surrounding environment and/or prevent the contents from inadvertently exiting the enclosure. Compared to user-improvised methods (e.g., rolling the top of a flexible bag), flexible enclosures are tidier and reassure the user that the contents are protected and will not spill if the enclosure is mispositioned or dropped.

In one configuration, the flexible enclosure includes a tear strip that extends across a front sidewall of the flexible enclosure. The tear strip may include a tab that is configured to be gripped and pulled by the user, thereby tearing the front sidewall open and allowing the user access to the contents. While known tear strip configurations can be sufficient for opening the enclosure, manufacturing enclosures with tear strips can be challenging. Moreover, some tear strip configurations may cause unwanted consequences, such as tearing undesired portions of the enclosure.

### BRIEF DESCRIPTION

In one embodiment, a flexible enclosure is provided that includes a front sidewall and a back sidewall that define an interior cavity of the flexible enclosure. The flexible enclosure also includes a resealable assembly including first and second zipper segments that are coupled with the front and back sidewalls, respectively, and are mateable with each other to enclose product within the interior cavity. The first and second zipper segments are releasable from each other to provide access to the product. The flexible enclosure also includes a tear strip having an elongated strip body that extends along the front sidewall. The tear strip also includes a pull tab that is accessible to a user along the front sidewall. The strip body defines an integrated portion of at least one of the first and second zipper segments. The strip body breaks from the resealable assembly and tears an access opening through the front sidewall when the pull tab is pulled away from the front sidewall by the user.

In one embodiment, a resealable assembly for joining opposing first and second sidewalls of a flexible enclosure is provided. The resealable assembly includes first and second zipper segments that are configured to couple with the front and back sidewalls, respectively, and are mateable with each other to enclose product within an interior cavity of the flexible enclosure. The first and second zipper segments are releasable from each other. The first zipper segment including an upper flange. The upper flange forms an elongated strip body that is configured to extend along the front sidewall. The strip body is defined by at least one frangible line of the upper flange, wherein the strip body is configured to break from the upper flange and tear an access opening through the front sidewall when the strip body is pulled by a user away from the front sidewall.

In one embodiment, a method is provided that includes providing a continuous web of flexible material. The continuous web having first zipper segments, second zipper segments, and elongated strip bodies that extend alongside corresponding first zipper segments. The method also includes separating an enclosure sheet from the continuous web. The enclosure sheet includes at least a first zipper segment and a second zipper segment and an elongated strip body that extends along the first zipper segment. The method also includes folding the enclosure sheet such that the first zipper segment and the second zipper segment are aligned with one another. The enclosure sheet, when folded, forms a first sidewall having the first zipper segment and the strip body and forms a second sidewall having the second zipper segment. The method also includes forming a cut-out through the first sidewall. The cut-out defines a pull tab coupled to an end of the strip body. The pull tab and the strip body form at least a portion of a tear strip of a flexible enclosure that is configured to tear an access opening through the first sidewall.

### BRIEF DESCRIPTION OF THE DRAWINGS

The inventive subject matter will now be illustrated with reference to the following figures, in which:

FIG. 1 is an isolated perspective view of a flexible enclosure formed in accordance with an embodiment,

FIG. 2A is a cross-section of a flexible enclosure having a tear strip in accordance with an embodiment,

FIG. 2B shows the flexible enclosure of FIG. 2A in which the tear strip has been removed, thereby opening the enclosure,

FIG. 3A is a cross-section of a front sidewall and back sidewall, prior to forming a flexible enclosure, in which the front sidewall includes a zipper segment having an integrated tear strip and peel material in accordance with an embodiment,

FIG. 3B is a cross-section of a flexible enclosure formed using the materials of FIG. 3A,

FIG. 3C shows the flexible enclosure of FIG. 3B in which the tear strip has been removed, thereby opening the enclosure,

FIG. 4 is a plan view of a portion of a flexible enclosure formed in accordance with an embodiment illustrating a tab of the tear strip,

FIG. 5 is a perspective cross-section of a front sidewall and back sidewall, prior to forming a flexible enclosure, in which the front and back sidewalls have been stamped to make a pull tab,

FIG. 6 is a perspective cross-section of a front sidewall and back sidewall, prior to forming a flexible enclosure, in which the front and back sidewalls have been stamped to make a pull tab,

FIG. 7 is a perspective cross-section of a front sidewall and back sidewall, prior to forming a flexible enclosure, in which an upper flange has been stamped to make a pull tab,

FIG. 8 is a perspective cross-section of a front sidewall and back sidewall, prior to forming a flexible enclosure, in which an upper flange has been stamped to make a pull tab,

FIG. 9 is a cross-section of a resealable assembly having first and second zipper segments in accordance with an embodiment,

FIG. 10 is a plan view of a flexible enclosure in which a pull tab is defined within a sealed frame of the flexible enclosure in accordance with an embodiment,

FIG. 11 is a plan view of a flexible enclosure in which a pull tab is defined within a sealed frame of the flexible enclosure in accordance with an embodiment,

FIG. 12A is an illustrative view of a tear strip that can be used in a flexible enclosure,

FIG. 12B is an illustrative view of another tear strip that can be used in a flexible enclosure, and

FIG. 12C is an illustrative view of yet another tear strip that can be used in a flexible enclosure.

### DETAILED DESCRIPTION

Embodiments set forth herein include flexible enclosures having tear strips and a resealable assembly (or resealer) having the tear strips. The flexible enclosure defines an interior cavity where the content is stored. The flexible enclosure may be initially opened by pulling a tear strip from the flexible enclosure. The tear strip tears an access opening through a front sidewall of the flexible enclosure. Embodiments also include a resealable assembly within the flexible enclosure. The resealable assembly has first and second zipper segments that are mateable and releasable from each other. Separating the first and second zipper segments provides a second access opening. Content may be passable through first and second access openings.

The resealable assembly permits a person to open the packaging to have access to the content and also close the packaging so that the content is held therein. The resealable assembly typically includes two features that oppose each other with an opening therebetween for accessing the content. These two features may be referred to as a resealer, although the resealable assembly may include additional features that do not assist in sealing the packaging. In the illustrated embodiment described below, the resealable assembly includes a resealable assembly having opposed first and second zipper segments.

Other embodiments, however, may include one or more other types of resealers. For example, the resealer may include at least one of an intermeshable closure member, parallel fastener strips, cooperating adhesive strips, hook-and-loop fastener elements, or a slider or a combination thereof. The resealer may include, for example, a track and a strip on opposing surfaces of the enclosure in which the strip fits within and along the track. Optionally, the resealer may include two tracks and two strips in which each track receives one strip. As another example, the resealer may include two opposing hook-filled lanes or strips. When brought together, the hooks of one lane couple to the hooks of the opposing lane, thereby sealing the enclosure. The hooks could be configured to engage on multiple levels. Optionally, the width of the lanes may be configured so that precise alignment is not required. The hooks may provide an audible and tactile response when the lanes are brought together for closing.

In some embodiments, a peel material is applied to a surface that interfaces with the back sidewall. The peel material may comprise a polymeric material. For example, the peel seal may comprise at least one of polyethylene (including a polyethylene copolymer), polypropylene, ionomers, amorphous polyester, vinyl acetate, polybutylene, or nylon EVOH. Non-limiting examples of peel material include polystyrene, polyethylene, polypropylene, poly(lactic acid), poly(vinyl chloride), polyamide-6, poly(ethylene naphthalate), poly(ethylene terephthalate), poly(m-xylylene adipamide), poly(vinyl alcohol), ethylene vinyl alcohol, and poly(vinylidene chloride).

In some embodiments, the zipper elements may be at least partially shaped from polypropylene (PP) or high-density polyethylene HDPE. Optionally, the zipper elements, or parts thereof (e.g., tear strip) may be made from a cyclic olefin cocopolymer (COC) resin that can provide higher strength and stiffness when compared with PP, HDPE, or other known materials. Providing greater strength and stiffness to the tear strip can enable the use of stronger materials in the layers of the pouch that may not otherwise be used for sealed packaging. Furthermore, the use of COC in the tear strip can allow for more consistent and reliable bag opening by the consumer.

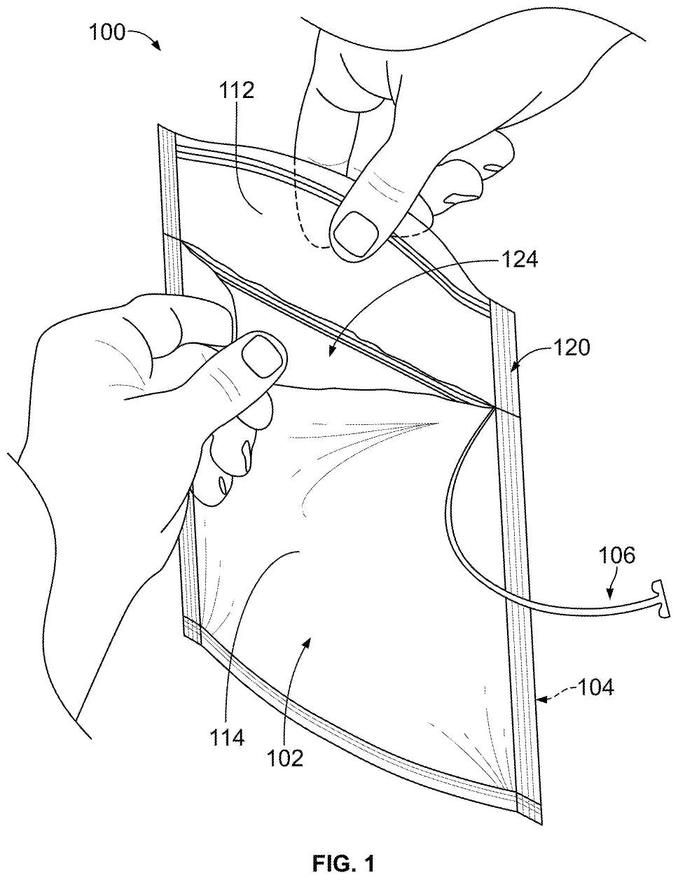

FIG. 1 illustrates a perspective view of a resealable flexible enclosure 100. In the illustrated embodiment, the flexible enclosure 100 includes a front sidewall (or first sidewall) 102, a back sidewall (or second sidewall) 104. In FIG. 1, a tear strip 106 has been pulled away from the front sidewall 102 thereby separating the front sidewall 102 into a first front section 112 (or top front section) and a second front section 114 (or bottom front section). With the tear strip 106, the first and second front sections 112, 114 provide an access opening 124 into an interior cavity of the flexible enclosure 100.

The sidewalls 102, 104 are discrete sections of a flexible material. In some embodiments, the discrete sections may be provided by different webs (or films) of the flexible material. Discrete sections are not portions of the same piece of flexible material. Discrete sections are typically cut from different webs or cut from the same web at different times. For example, the front sidewall 102 may be obtained from a first continuous web of flexible material, the back sidewall 104 may be obtained from a different second continuous web of the same flexible material. Yet in some embodiments, the front and back sidewalls 102, 104 may be formed by folding the same sheet of material onto itself.

In the illustrated embodiment, the front sidewall 102 and the back sidewall 104 are directly attached to each other along a sealed frame 120. The sealed frame 120 includes corresponding edges of the front and back sidewalls 102, 104 being sealed to one another. As shown, the sealed frame 120 extends along a perimeter of the flexible enclosure 100.

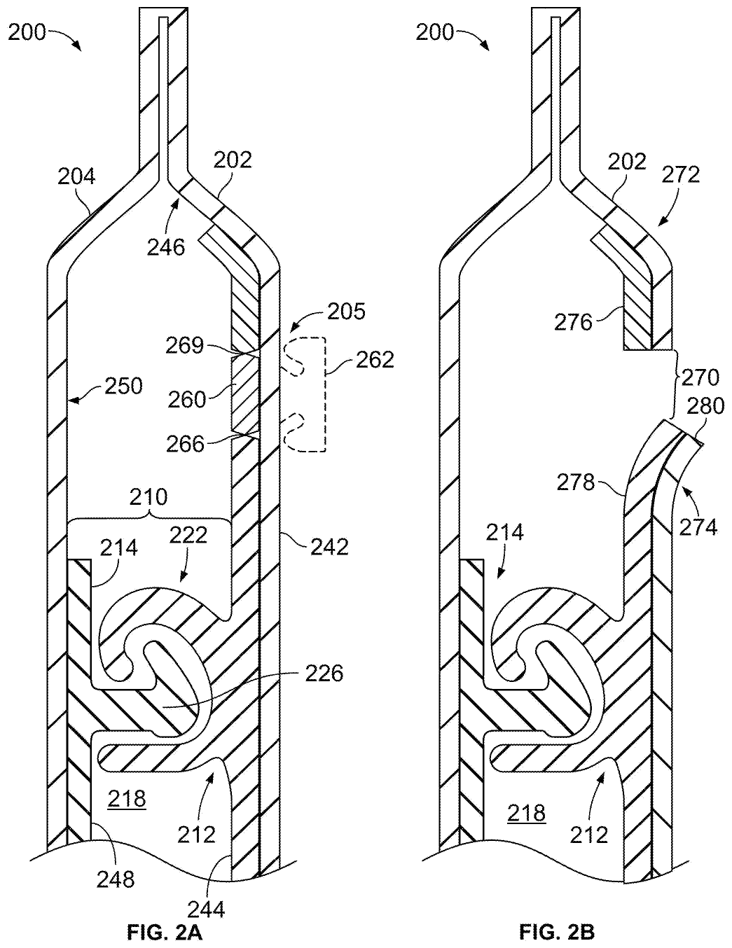

FIG. 2A is a cross-section of a resealable flexible enclosure 200 having a tear strip 205 in accordance with an embodiment. The flexible enclosure 200 includes a first sidewall 202 and a second sidewall 204. A resealable assembly 210 of the flexible enclosure 200 is positioned between the first and second sidewalls 202, 204. The resealable assembly 210 includes a first zipper segment or segment 212 and a second zipper segment or segment 214 that are configured to mate with each other to enclose product within an interior cavity 218 of the flexible enclosure 200. In the illustrated embodiment, the first sidewall 202 is secured to a first zipper segment 212, and the second sidewall 204 is secured to a second zipper segment 214.

The first and second zipper segments 212, 214 unmate or release from each other to provide access to the product within the interior cavity 218. In the illustrated embodiment, the first zipper segment 212 has a female interlocking element 222. The second zipper segment 214 has a male interlocking element 226. When the first and second zipper segments 212, 214 are mated, the female interlocking element 224 of the first zipper segment 212 receives the male interlocking element 226 of the second zipper segment 214.

The first zipper segment 212 has an upper flange 242 extending away from the interlocking element 222 and a lower flange 244 extending away from the interlocking elements 222. Each of the upper and lower flanges 242, 244 are secured to different areas of an interior surface 246 of the first sidewall 202. The second zipper segment 214 has a lower flange 248 extending away from the interlocking element 226. The lower flange 248 is secured to an interior surface 250 of the second sidewall 204. The upper flange 242 is affixed to the interior surface 246, and the lower flanges 244, 248 are each affixed to the interior surfaces 246, 250 of the first and second sidewalls 202, 204. As such, the first and second sidewalls 202, 204 are coupled to one another through the first and second zipper segments 212, 214. As described herein, the first and second sidewalls 202, 204 are also coupled through a sealed frame, in which edges of the first and second sidewalls 202, 204 are sealed to each other.

The interior cavity 218 includes a portion above the resealable assembly 210, and a portion below the resealable assembly 210. The portion above the resealable assembly 210 may be referred to as an entry portion 292 and the portion below the resealable assembly 201 may be referred to as a content portion 294.

The flexible enclosure 200 may be formed from various materials, including plastic and/or thermoplastic films, such as but not limited to polyethylene, polypropylene, etc. In some embodiments, a single continuous layer may be folded to provide the first and second sidewalls 202, 204. The first and second sidewalls 202, 204 may be coupled with one another (e.g., heat sealed) to define the interior cavity 218. As shown, the flexible enclosure 200 includes a sealed frame 250 where edges of the first and second sidewalls 202, 204 have been sealed. The sealed frame 250 includes a top section 252 that partially defines the entry portion 292.

The upper flange 242 extends toward the top section 230 along the first sidewall 202. In some embodiments, portions of the upper flange 242 may be used to provide the tear strip 205 and portions may be used to provide structural integrity to the flexible enclosure after the tear strip 205 has been removed.

The tear strip 205 includes an elongated strip body 260 that extends along the front sidewall 202. In FIG. 2, only a cross-section of the strip body 260 is shown as the elongated strip body would extend into and out of the page. The tear strip 205 also includes a pull tab 262 that is configured to be accessible to a user along the front sidewall 202. The pull tab 262 is shown as dashed to indicate is positioned out of the page.

In particular embodiments, the strip body 260, the upper flange 242, the lower flange 244, and the interlocking element 222 are portions of a common part or piece of material. For example, the zipper element 212 may be molded from a polymeric material. Optionally, the zipper element 212 may include frangible lines 264, 266 that represent weaker regions of the zipper element 212 that are configured to break or tear, such as when a user pulls the pull tab. The frangible lines may also be referred to as lines of weakness. The frangible lines 264, 266 may be shaped during a molding process. Alternatively, the frangible lines 264 may be provided after the shaping process. For example, material may be etched or pressed to weaken the upper flange 242 along the frangible lines 264, 266. Accordingly, the strip body 260 may be an integrated portion of the first zipper segment 212 that is configured to be removed when a user pulls the tear strip 205.

FIG. 2B is a cross-section of the flexible enclosure 200 after the tear strip 205 (FIG. 2A) has been removed. The pull tab 262 (FIG. 2A) is configured to be gripped by a user and pulled away from the front sidewall 202. As the pull tab 262 is moved away from the front sidewall 202, the strip body 260 (FIG. 2A) breaks from the first zipper segment 212. The strip body 260 tears through the front sidewall 202, thereby forming an access opening 270 through the front sidewall 202.

The access opening 270 separates the front sidewall 202 into a first front section 272 and a second front section 274. As shown, the upper flange 242 may also be divided into two sections. More specifically, a first upper flange section 276 extends along the first front section 272 of the front sidewall 202, and a second upper flange section 278 extends along the second front section 274. The first and second upper flange sections 276, 278 may enhance structural integrity of the first and second front sections 272, 274. For example, a user may feel a stronger structure of the first and second front sections 272, 274 of the front sidewall 202 that include the upper flange sections 276, 278. The stronger structure may be appreciated when gripping the second front section 274 to separate the first and second zipper segments 212, 214 and obtain access to the interior cavity 218. In FIG. 2B, the second upper flange section 278 is sealed to the second front section 274 and has a frayed edge 280 exposed to the access opening 270.

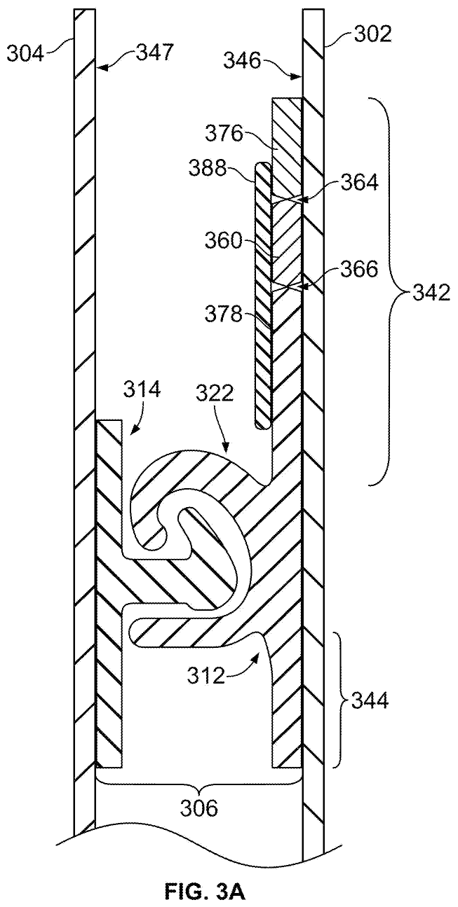

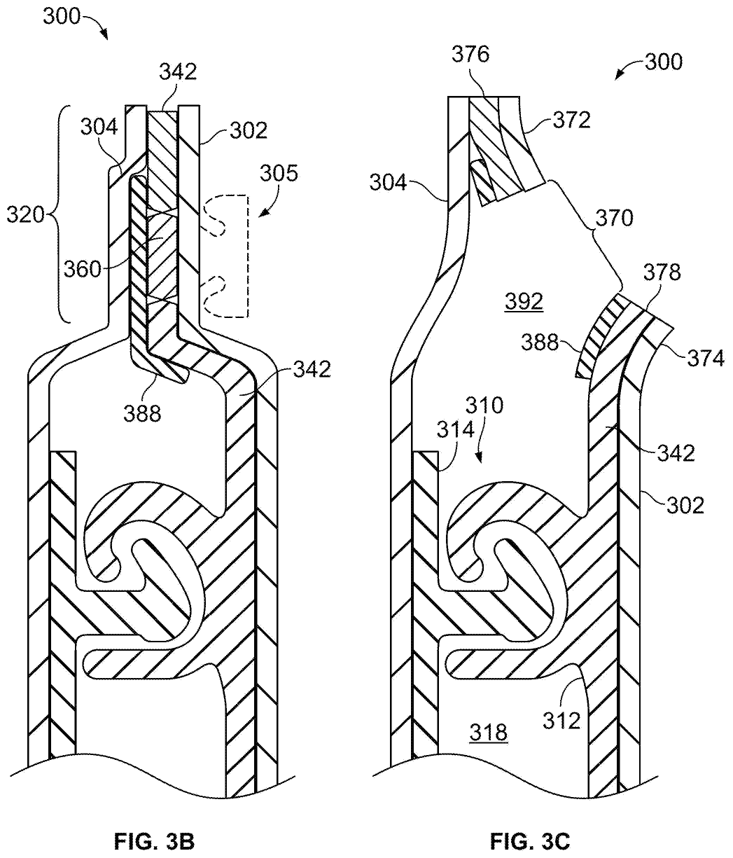

FIG. 3A is a cross-section of a front sidewall 302 and back sidewall 304 and a resealable assembly 306 therebetween, prior to forming a flexible enclosure, such as the flexible enclosure 200 (FIG. 2A). In FIG. 3A, the resealable assembly 306 may already be secured to the opposing first and second sidewalls 302, 304 or merely positioned for sealing (e.g., heat sealing). The resealable assembly 306 includes a first zipper segment 312 and a second zipper segment 314 that are configured to couple with the front and back sidewalls 302, 304, respectively.

In the illustrated embodiment, the first zipper segment 312 is a single, shaped piece of material that includes multiple portions formed during a shaping process (e.g., molding or etching). The portions include an upper flange 342, an interlocking element 322, and a lower flange 344. The upper flange 342 extends along and is secured to an interior surface 346 of the front sidewall 302. The upper flange 342 is shaped to include a first flange portion 376, a second upper flange section 378, and an elongated strip body 360 that extends between the first and second flange portions 376, 378. The strip body 360 may be defined by at least one frangible line of the upper flange 342. For example, the strip body 360 is defined between two frangible lines 364, 366. The first flange portion 376 borders the strip body 360 along the frangible line 364. The second flange portion 378 extends away from the interlocking element 322 and borders the strip body 360 along the frangible line 366.

As shown in FIG. 3A, embodiments may include a peelable material 388 that is applied along the upper flange 342. For example, the peelable material 388 may be applied along at least the strip body 360 and the second upper flange section 378. Optionally, the peelable material 388 may also be applied to the first upper flange section 376. The peelable material 388 may comprise a polymeric material that is configured to inhibit or impede a strong bond between the upper flange 342 and an interior surface 347 of the back sidewall 304. For example, the peelable material 388 may comprise a blend of polybutylene and polyethylene. When the first and second sidewalls 302, 304 are heat-sealed, the upper flange 342 is also sealed to the interior surface 346 of the first sidewall 302. However, the peelable material 388 may prevent at least a portion of the upper flange 342 from sufficiently bonding or sealing with the second sidewall 304. As such, the peelable material 388 disposed between the upper flange section 342 and the back sidewall 304 may allow the upper flange section 342, including the strip body 360 and the second upper flange section 378, to readily separate from the back sidewall 304. For some configurations, the peelable material 388 may require a higher temperature for sealing compared to other materials in the heat-sealing process. As such, other materials (e.g, the upper flange and the front sidewall) can be sealed together at a lower temperature while the peelable material 388 may not form a seal with the back sidewall 304. For example, the peelable material 388 may comprise polypropylene (PP) or high-density polyethylene (HDPE).

In particular embodiments, the strip body may comprise at least one of cyclic olefin cocopolymer (COC), PP, or HDPE. Optionally, the strip body 360 may include a sealant coating, such as metallocene linear low density polyethylene (mLLDPE), positioned along an interface between the strip body 360 and the front sidewall 302.

FIG. 3B is a cross-section of a flexible enclosure 300 formed using the components shown in FIG. 3A. Through a heat-sealing process, portions of the front sidewall 302, the upper flange 342, the peelable material 388, and the back sidewall 304 are sandwiched together to form a portion of a sealed frame 320. FIG. 3C is a cross-section of the flexible enclosure 300 after a tear strip 305 (FIG. 3A) has been removed (e.g., torn) from the flexible enclosure. With respect to FIGS. 3B and 3C, the peelable material 388 allows the strip body 360 to separate from the back sidewall 304 more readily, as compared to separating from the back sidewall 304 without the peelable material 388. Moreover, the peelable material 388 increases the likelihood that the back sidewall 304 will remain undamaged by the tear strip 305. More specifically, the strip body 360 may not pull and tear a portion of the back sidewall 304 with the strip body 360 when the strip body 360 is removed.

The upper flange 342 can provide additional support to the front sidewall 302 during the tearing process. The added thickness and rigidity can provide a more even tear compared to configurations without the upper flange. As shown in FIG. 3C, an access opening 370 separates the front sidewall 302 into a first front section 372 and a second front section 374. The access opening 370 opens an entry portion 392 of the interior cavity 318 to the user and allows access to a resealable assembly 310. The upper flange 342 is also divided and includes a first upper flange section 376 extending along the first front section 372 and a second upper flange section 378 extending along the second front section 374. The first and second upper flange sections 376, 378 may enhance a structural integrity of the first and second front sections 372, 374, respectively. Moreover, the first and second upper flange sections 376, 378 may aid the user in separating first and second zipper segments 312, 314 of the resealable assembly 310.

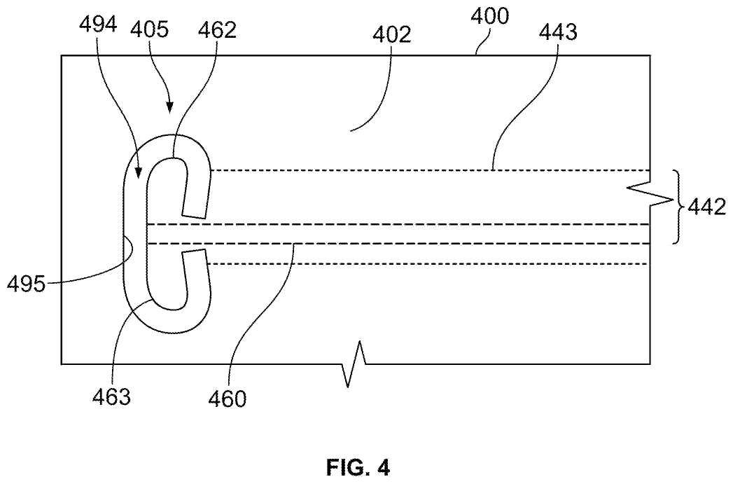

FIG. 4 is a front view of a portion of a flexible enclosure 400 having a tear strip 405 that includes an elongated strip body 460 and a pull tab 462. As shown, the string body 460 is positioned behind a front sidewall 402 and as a portion of an upper flange 442. A top edge 443 of the upper flange 442 is shown in phantom. A top edge 415 of a second or rear zipper element 414 is also shown. In the illustrated embodiment, the string body 460 is positioned above the top edge 415 of the second zipper element 414.

In FIG. 4, the front sidewall 402 has a tab window 494 defined by an inner edge 495 of the front sidewall 402. The tab window 494 may be formed by stamping (or punching) the front sidewall 402. The pull tab 462 includes a distal edge 463 that defines a shape of the pull tab 462 and is also formed during the stamping process. As shown, the inner edge 495 surrounds the pull tab 462. In the illustrated embodiment, the pull tab 462 includes an end of the strip body 460 and a stamped section of the front sidewall 402. Optionally, the pull tab 462 may include a stamped section of the back sidewall.

FIG. 5 is a perspective cross-section of a front sidewall 502 and back sidewall 504 prior to forming a flexible enclosure. The back sidewall 504 includes a hole 570 punched therethrough. The hole 570 includes an edge of the back sidewall 504 such that the hole opens to the edge. The punching can be performed prior to the back sidewall 504 and the front sidewall 502 being formed/folded to overlap one another. In some embodiments, after a zipper segment 512 is attached to the front sidewall 502 and a punch is used to form the pull tab 562. The punch cuts thru the front sidewall 502, an upper flange 542 and optionally a portion of a rear flange 514. The second punch leaves a portion of the front sidewall 502 and both the upper flange 542 and the rear flange 514 still attached. The second punching process can occur prior to, or after, a side seal or supplemental seal is formed around the pull tab.

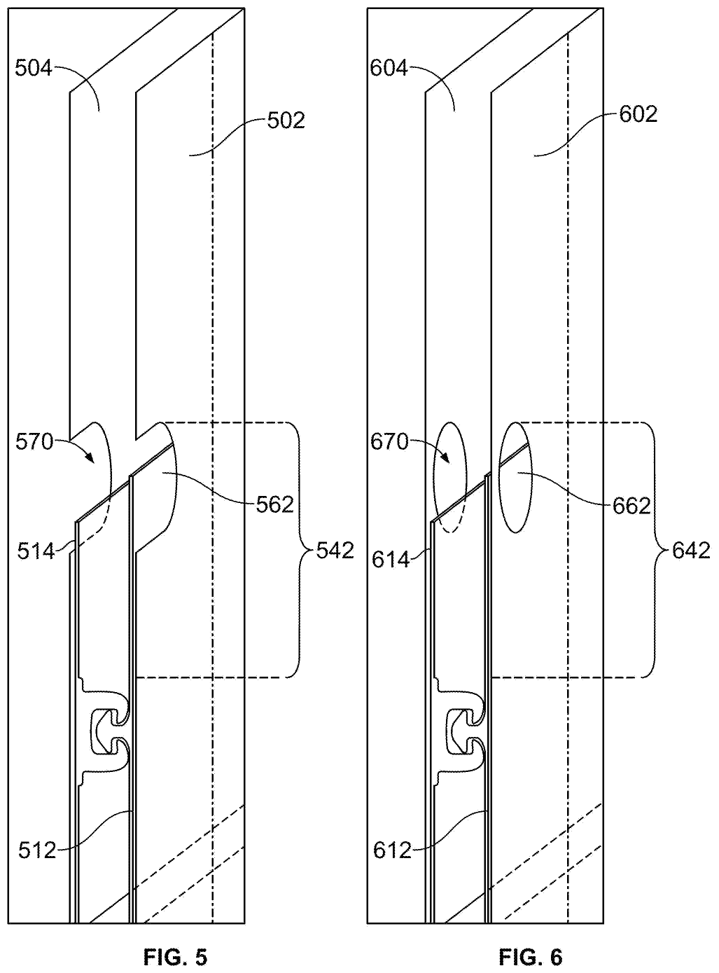

FIG. 6 is a perspective cross-section of a front sidewall 602 and back sidewall 604 prior to forming a flexible enclosure. The back sidewall 604 includes a hole 670 punched therethrough. In FIG. 6, the hole 670 does not include an edge of the back sidewall 604. Instead, the hole 670 is entirely defined by an inner edge of the back sidewall 604. The punching can be performed prior to the back sidewall 604 and the front sidewall 602 being formed/folded to overlap one another. In some embodiments, after a zipper segment 612 is attached to the front sidewall 602 and a punch is used to form the pull tab 662. The punch cuts thru the front sidewall 602, an upper flange 642 and optionally a portion of a rear flange 614. The second punch leaves a portion of the front sidewall 602 and both the upper flange 642 and the rear flange 614 still attached. The second punching process can occur prior to, or after, a side seal or supplemental seal is formed around the pull tab.

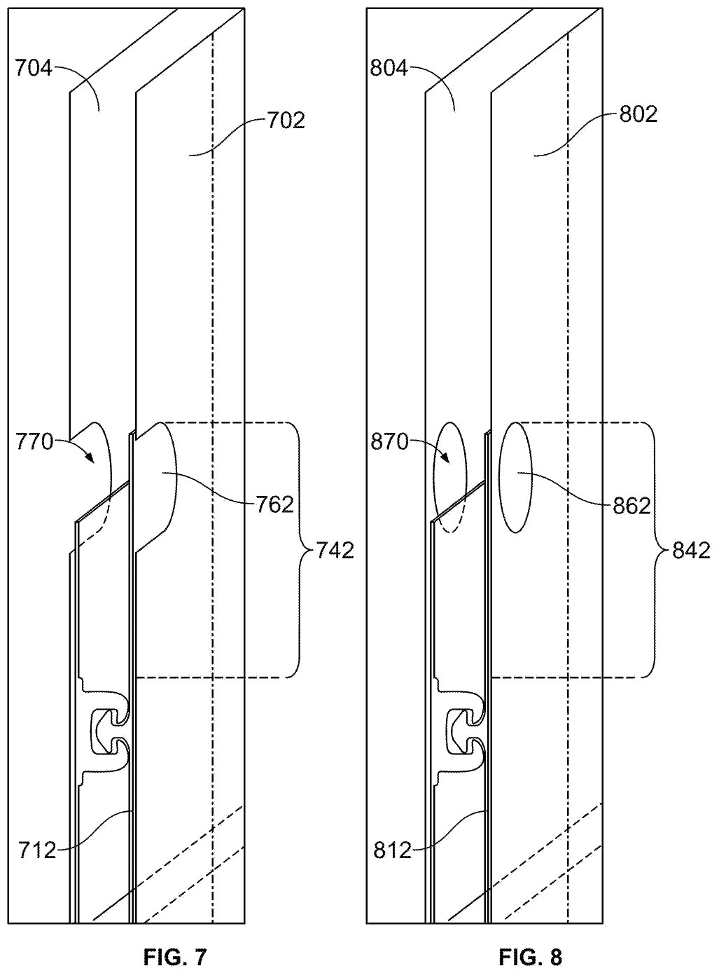

FIGS. 7 and 8 illustrate embodiments in which the pull tab may be entirely or nearly entirely shaped by a portion of an upper flange. FIG. 7 is a perspective cross-section of a front sidewall 702 and back sidewall 704 prior to forming a flexible enclosure. The back sidewall 704 includes a hole 770 punched therethrough. The hole 770 includes an edge of the back sidewall 704 such that the hole opens to the edge. The punching can be performed prior to the back sidewall 704 and the front sidewall 702 being formed/folded to overlap one another. In some embodiments, after an upper flange 742 including a zipper segment 712 is attached to the front sidewall 702, a punch is used to form the pull tab 762. The punch cuts thru the front sidewall 702, the upper flange 742 and optionally a portion of a rear flange 714. The second punching process can occur prior to, or after, a side seal or supplemental seal is formed around the pull tab.

FIG. 8 is a perspective cross-section of a front sidewall 802 and back sidewall 804 prior to forming a flexible enclosure. The back sidewall 804 includes a hole 870 punched therethrough. In FIG. 8, the hole 870 does not include an edge of the bak sidewall 804. Instead, the hole 870 is entirely defined by an inner edge of the back sidewall 804. The punching can be performed prior to the back sidewall 804 and the front sidewall 802 being formed/folded to overlap one another. In some embodiments, after an upper flange 842 having a zipper segment 812 is attached to the front sidewall 802, a punch is used to form the pull tab 862. The punch cuts thru the front sidewall 802, an upper flange 842 and optionally a portion of a rear flange 814. The second punching process can occur prior to, or after, a side seal or supplemental seal is formed around the pull tab.

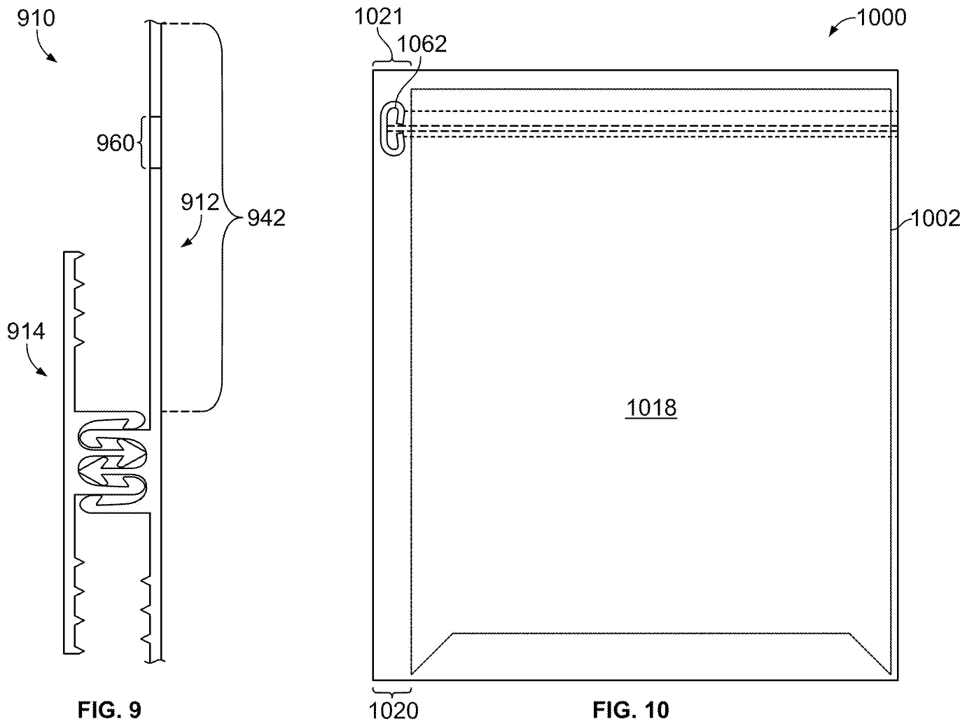

FIG. 9 is a cross-section of a resealable assembly 900 that is configured to join opposing first and second sidewalls of a flexible enclosure (not shown). The resealable assembly includes first and second zipper segments 912, 914 that are configured to couple with the front and back sidewalls, respectively. The first and second zipper segments 912, 914 are mateable with each other and are releasable from each other. The first zipper segment 912 includes an upper flange 942. The upper flange 942 forms an elongated strip body 960 that is configured to extend along the front sidewall. The strip body 960 may be defined between two frangible line of the upper flange 942. In some embodiments, the strip body 960 is a portion of the upper flange 942 such that the upper flange 942 and the strip body 960 are formed from the same material. In other embodiments, however, the strip body 960 and the upper flange 942 include different materials and the strip body 960 is separately attached to the upper flange 942.

FIG. 10 is a plan view of a flexible enclosure 1000 in which a pull tab 1062 is defined within a sealed frame 1020 of the flexible enclosure 1000. The sealed frame 1020 surrounds an interior cavity 1018 and extends along a perimeter of the flexible enclosure 1000. The sealed frame 1020 includes a portion of a front sidewall 1002 and at least one other sidewall of the flexible enclosure being sealed to one another. The other sidewall may be a back sidewall, as described herein, or a connecting wall or gusset that extends between the front and back sidewalls. The pull tab 1062 is formed from a portion of the sealed frame 1020. As shown, a width 1021 of the sealed frame 1020 is essentially constant along an edge of the flexible enclosure 1000 and includes the pull tab 1062. This is contrary to known flexible enclosures that require a complex sealed frame configuration to accommodate the pull tab.

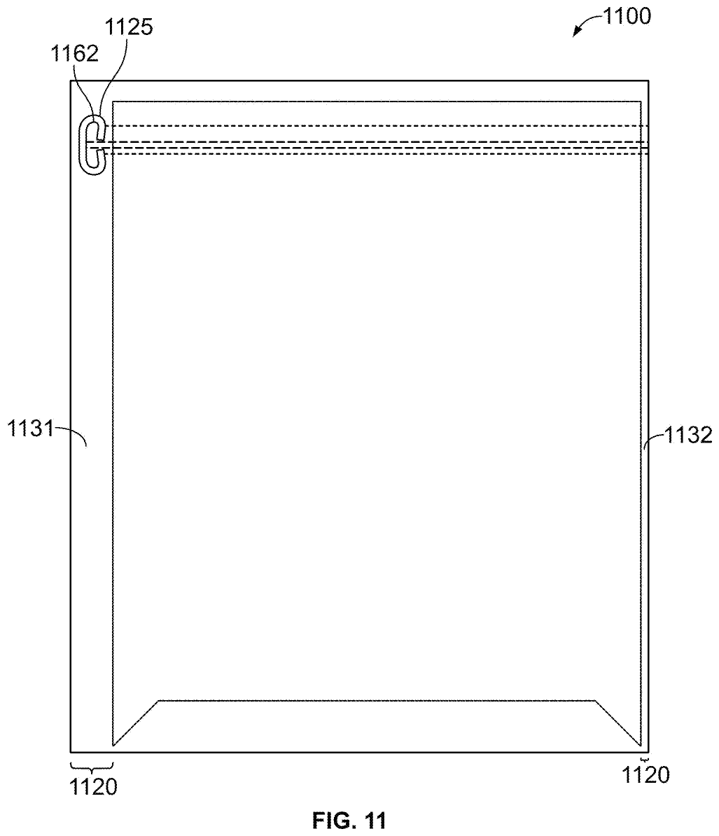

FIG. 11 is a plan view of a flexible enclosure 1100 in which a pull tab 1162 is defined within a tab window 1125 of an adjusted sealed frame 1120 of the flexible enclosure 1100. The sealed frame 1120 extends along a perimeter of the flexible enclosure 1000. As shown, the sealed frame 1120 is wider along a first edge section 1131 of the sealed frame 1120 that includes the tab window 1125 compared to a second edge section 1132 of the sealed frame 1120 that is opposite the first edge section 1131 and does not include a tab window.

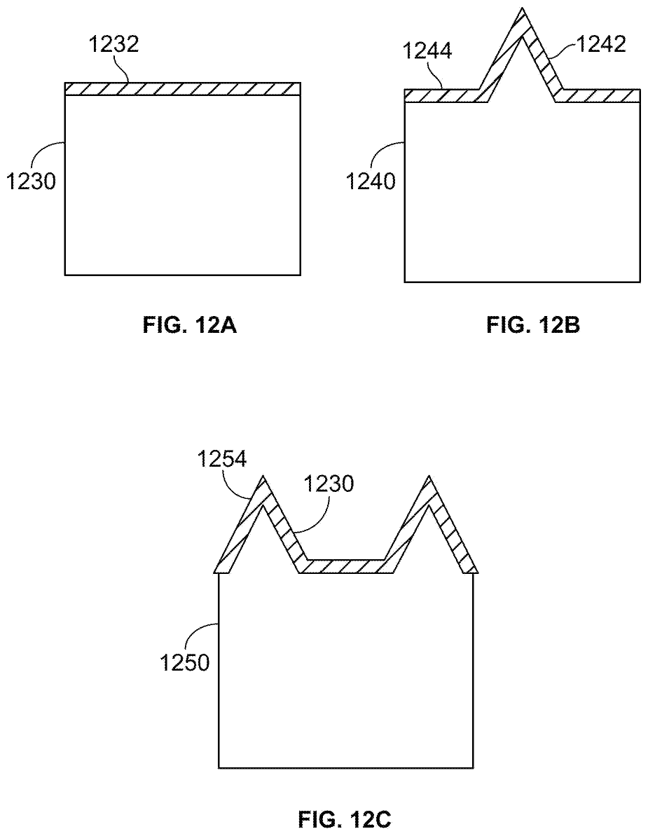

FIGS. 12A-12C are schematic illustrations of exemplary cross-sections of a tear strip 1212. Referring now to FIG. 12A, the tear strip 1212 may be an elongated body 1230 having a generally rectangular cross-section when viewed in the plane of the page of FIG. 12A. For descriptive purposes, the plane of the pages of FIGS. 12A-11C can be generally perpendicular to the plane of the page. Referring now to FIG. 12B, the tear strip 1212 may be an elongated body 1240 having a protrusion 1242 formed along the length of the elongated body 1240. The elongated body 1240 may have a generally rectangular cross-section and the protrusion 1242 may have a generally triangular cross-section that forms a sharp edge along the tear strip 1212. Referring now to FIG. 12C, the tear strip 1212 may be an elongated body 1250 having multiple protrusions 1252 formed along the length of the elongated body. The elongated body 1250 may have a generally rectangular cross-section and the protrusions 1252 may have a generally triangular cross-section forming multiple sharp edges along the elongated body 1250.

In one example, the protrusions 1242, 1252 may be in contact with layers, films, or panels of the flexible enclosure and can provide a sharp peak on the tear strip 1212 to cut through the flexible enclosure as the customer grabs and pulls the tear strip 1212 to open the flexible enclosure. The sharp peaks of the protrusions 1242, 1252 can reduce the amount of force a consumer uses to tear the layers of the flexible enclosure relative to the amount of force needed to tear the layer of the flexible enclosure using a blunt or flat cross-sectional profile. In one example, the protrusions 1242, 1252 may have other cross-sectional shapes yielding a sharp edge along the tear strip. For example, the protrusions 1242, 1252 may be square, rectangular, elliptical, pentangular, among others.

In one example, the protrusions 1242, 1252 can cut into, or score, one or more layers of the front sidewall. The tear strip 1212 can be sealed or joined to the interior layer 16. Joining the tear strip 1212 to the interior layer front sidewall may be done by heat sealing the tear strip 1212 (or the upper flange) to an interior surface along the length of the tear strip 1212. The tear strip 1212 can have a heat seal coating 1232, a heat seal coating 1244, or a heat seal coating 1254, respectively to enhance the heat sealing of the tear strip 1212 to the interior layer. The heat seal coatings 1232, 1244, 1254 may improve the coupling of the tear strip 1212 to the flexible enclosure.

In one example, the elongated body 1240, for example, can extend along a first direction from a first end to an opposite, second end, and the protrusion 1242 can extend along the first direction from the first end of the elongated body 1240 toward, but not entirely to, the second end of the elongated body 1240. In other words, the protrusion 1242 or the protrusions 1252 can be discrete features distributed along the length of the elongated body 1240 or the elongated body 1250, respectively. The protrusions 1242, 1252 may be continuous along the length of the elongated body. The protrusions 1242, 1252 can be provided on a portion of the elongated body. In one example, the protrusions 1242, 52 may be discrete segments separated by gaps along the elongated body. In one example, the protrusions 1242, 1252 may be located towards the center of the flexible enclosure. The tear strip 1212 may be accessed through an opening located on an edge or in within the body of the flexible enclosure. The tear strip 1212 may be provided over a portion of the interior layers within the middle portion of the flexible enclosure. For example, the tear strip 1212 may extend from one edge of the flexible enclosure and terminate in the middle portion of the flexible enclosure. In one example, the tear strip 1212 may be located within the middle portion of the flexible enclosure and not contact an edge of the flexible enclosure.

A flexible enclosure can be manufactured by placing a tear strip assembly between opposing first and second panels of an enclosure, the tear strip assembly may include a tear strip 1212 having an elongated body formed from a cyclic olefin copolymer (COC) material. The tear strip assembly may include a coupling material or other components such as a zipper flange, drawstring, or other resealing device. The tear strip assembly can be placed such that only a portion of the tear strip assembly is accessible through the access opening. The flexible enclosure can be formed with an access opening through the first panel of the enclosure to expose a portion of the tear strip assembly, wherein the elongated body of the tear strip assembly is placed for being pulled away from the second panel to tear through the first panel and provide access into the enclosure, the COC material of the tear strip assembly configured to assist in cutting through the first panel as the elongated body is pulled away from the second panel.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are example embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A flexible enclosure comprising:
a front sidewall and a back sidewall that define an interior cavity of the flexible enclosure;
a resealable assembly including first and second zipper segments that are coupled with the front and back sidewalls, respectively, and are mateable with each other to enclose product within the interior cavity, the first and second zipper segments being releasable from each other to provide access to the product; and
a tear strip having an elongated strip body that extends along the front sidewall, the tear strip also including a pull tab that is accessible to a user along the front sidewall, wherein the strip body defines an integrated portion of at least one of the first and second zipper segments, the strip body breaking from the resealable assembly and tearing an access opening through the front sidewall when the pull tab is pulled away from the front sidewall by the user.

2. The flexible enclosure of claim 1, wherein the first zipper segment includes an upper flange extending along an interior surface of the front sidewall, the strip body defining a portion of the upper flange, the strip body breaking from the upper flange when the pull tab is pulled away from the front sidewall by the user.

3. The flexible enclosure of claim 2, wherein the strip body is defined between frangible lines of the upper flange.

4. The flexible enclosure of claim 2, wherein the upper flange is sealed to the front sidewall and has a frayed edge exposed to the access opening.

5. The flexible enclosure of claim 2, wherein the front and back sidewalls are sealed to each other with the upper flange therebetween, wherein a peelable material extends between the back sidewall and at least the strip body of the upper flange, the peelable material allowing the strip body to separate from the back sidewall while the front and back sidewalls remain sealed to one other.

6. The flexible enclosure of claim 1, wherein the pull tab includes stamped material from at least the front sidewall and a portion of the strip body.

7. The flexible enclosure of claim 1, wherein the first zipper segment includes an upper flange extending along an interior surface of the front sidewall, the strip body defining a portion of the upper flange, wherein the pull tab includes stamped material from a portion of the upper flange.

8. The flexible enclosure of claim 1, further comprising a sealed frame extending along a perimeter of the flexible enclosure, the sealed frame including the front sidewall and at least one other sidewall of the flexible enclosure sealed to one another, the sealed frame including an exterior edge of the flexible enclosure, wherein the pull tab includes a portion of the exterior edge, the portion of the exterior edge of the pull tab either being entirely separated from a remainder of the sealed frame or being frangibly connected to the front sidewall.

9. The flexible enclosure of claim 1, wherein the front sidewall includes a tab window defined by an inner edge and the pull tab includes a distal edge, wherein the inner edge surrounds the pull tab including the distal edge.

10. The flexible enclosure of claim 9, wherein the flexible enclosure includes a sealed frame extending along a perimeter of the flexible enclosure, the sealed frame including the front sidewall and at least one other sidewall of the flexible enclosure sealed to one another, wherein the pull tab is formed from a portion of the sealed frame, the sealed frame being wider along a first section of the sealed frame that includes the tab window compared to a second section of the sealed frame that is opposite the first section.

11. A resealable assembly for joining opposing first and second sidewalls of a flexible enclosure, the resealable assembly comprising:
first and second zipper segments that are configured to couple with the first and second sidewalls, respectively, the first and second zipper segments being mateable with each other to enclose product within an interior cavity and being releasable from each other, the first zipper segment including an upper flange; and
wherein the upper flange forms an elongated strip body that is configured to extend along the first sidewall, the strip body being defined by at least one frangible line of the upper flange, wherein the strip body is configured to break from the upper flange and tear an access opening through the first sidewall when the strip body is pulled by a user away from the first sidewall.

12. The resealable assembly of claim 11, further comprising a peelable material extending along at least the strip body of the upper flange, the peelable material configured to allow the strip body to separate from the second sidewall while the first and second sidewalls remain sealed to one other.

13. The resealable assembly of claim 12, wherein the peelable material comprises at least one of polybutylene or polyethylene.

14. The resealable assembly of claim 11, wherein the strip body is defined between at least two frangible lines, the strip body dividing the upper flange into two flange sections when pulled by a user away from the first sidewall.

15. The resealable assembly of claim 11, wherein the upper flange is shaped to form a pull tab coupled to an end of the strip body, the pull tab and the strip body forming at least a portion of a tear strip of the flexible enclosure.

16. A method comprising:
providing a continuous web of flexible material, the continuous web having first zipper segments, second zipper segments, and elongated strip bodies that extend alongside corresponding first zipper segments;
separating an enclosure sheet from the continuous web, the enclosure sheet including at least a first zipper segment and a second zipper segment and an elongated strip body that extends along the first zipper segment;
folding the enclosure sheet such that the first zipper segment and the second zipper segment are aligned with one another, wherein the enclosure sheet, when folded, forms a first sidewall having the first zipper segment and the strip body and forms a second sidewall having the second zipper segment; and
forming a cut-out through the first sidewall, the cut-out defining a pull tab coupled to an end of the strip body, the pull tab and the strip body forming at least a portion of a tear strip of a flexible enclosure that is configured to tear an access opening through the first sidewall.

17. The method of claim 16, wherein the first zipper segment includes an upper flange extending along the first sidewall, the strip body defining a portion of the upper flange, the strip body breaking from the upper flange when the pull tab is pulled away from the first sidewall.

18. The method of claim 17, further comprising:
sealing the first sidewall and the second sidewall with the upper flange therebetween; and
prior to sealing the first and second sidewalls, applying a layer of peelable material such that the peelable material is disposed between the upper flange and the second sidewall, the peelable material configured to allow the strip body to separate from the second sidewall while the first and second sidewalls remain sealed to one other.

19. The method of claim 16, wherein forming the cut-out includes defining the pull tab, the pull tab including shaped material from a portion of the upper flange.

20. The method of claim 16, wherein the first zipper segment and the strip body are portions of a common shaped piece, the method further comprising forming at least two frangible lines to define the strip body.
